(19) United States
(12) Patent Application Publication
(10) Pub. No.: US 2011/0061449 A1
(43) Pub. Date: Mar. 17, 2011

(54) ELECTRONIC DEVICE

(75) Inventors: Hitoshi YAGI, Kanagawa-Ken (JP); Hideyuki FUNAKI, Tokyo (JP); Hiroto HONDA, Kanagawa-ken (JP)

(73) Assignee: Kabushiki Kaisha Toshiba, Tokyo (JP)

(21) Appl. No.: 12/888,460

(22) Filed: Sep. 23, 2010

Related U.S. Application Data
(63) Continuation of application No. PCT/JP2009/064268, filed on Aug. 12, 2009.

(30) Foreign Application Priority Data
Sep. 18, 2008 (JP) 2008-240025

(51) Int. Cl. G01M 3/02; G01J 5/00

(52) U.S. Cl. 73/49.2; 250/338.1

(57) ABSTRACT

According to one embodiment, an electronic device includes an airtight container, a functioning unit, and an airtightness detection unit. The airtight container has a containment space capable of being sealed airtightly. The functioning unit is stored in the containment space. The functioning unit is capable of executing a prescribed function. The airtightness detection unit is stored in the containment space. The airtightness detection unit is capable of detecting an airtightness of the containment space.

### CROSS-REFERENCE TO RELATED APPLICATIONS

This is a continuation application of International Application PCT/JP2009/064268, filed on Aug. 12, 2009. This application also claims priority to Japanese Application No. 2008-240025, filed on Sep. 18, 2008. The entire contents of each are incorporated herein by reference.

### FIELD

Embodiments described herein relate generally to an electronic device.

### BACKGROUND

In recent years, micro electro mechanical systems (MEMS) technology has been developed actively to realize small high-performance electronic devices by forming structures capable of mechanical operations and three-dimensional structures on substrates based on semiconductor integrated circuit technology. A wide variety of electronic devices have been developed such as, for example, acceleration sensors, pressure sensors, flow rate sensors, infrared imagers, RF switches, RF oscillators, microactuators, resonator filters, DNA chips, etc.

For many such electronic devices, the packaging to provide protection from the external environment requires a package having a hollow structure instead of the packaging technology such as resin molds which have been used in LSI technology. Further, a vacuum package is often necessary to maintain the performance of the electronic device over long periods of time.

For example, an infrared imager obtains an infrared image signal by converting incident infrared rays into heat using an infrared absorption unit, converting the temperature change occurring due to the faint heat into an electrical signal using a thermo electric conversion unit, and by reading the electrical signal. The infrared sensitivity of such an infrared imager has been increased by providing a cavity around the thermo electric conversion unit to thermally separate the thermo electric conversion unit from the surroundings and by mounting in a vacuum package.

For acceleration sensors, microactuators, and the like having movable portions, the inside of the package is a vacuum or is filled with a gas with an airtight seal to increase the reproducibility of the movable portion and to suppress changes over time.

In such electronic devices, the fluctuation of the number of gaseous molecules existing in the package, i.e., the fluctuation of the degree of vacuum or the fluctuation of the partial pressure of the sealed element, is one main factor that determines the long-term reliability of the electronic device. For example, in the case of an infrared imager, the electrical characteristics of the thermo electric conversion unit change, image deterioration occurs, etc., and the reliability undesirably decreases when the degree of vacuum in the vacuum package decreases, even in the case where the performance of the thermo electric conversion unit does not change.

### BRIEF DESCRIPTION OF THE DRAWINGS

FIG. 1 is a schematic cross-sectional view illustrating an electronic device according to a first embodiment;

FIG. 2 is a schematic cross-sectional view illustrating the main components of an electronic device according to a first example;

FIGS. 3A and 3B are conceptual schematic views illustrating characteristics of elements which can be used in an electronic device according to an embodiment;

FIG. 4 is a schematic cross-sectional view illustrating the main components of an electronic device according to a second example;

FIG. 5 is a schematic cross-sectional view illustrating the main components of an electronic device according to a third example;

FIG. 6 is a schematic cross-sectional view illustrating the main components of an electronic device according to a fourth example;

FIG. 7 is a schematic cross-sectional view illustrating the main components of an electronic device according to a fifth example;

FIG. 8 is a schematic cross-sectional view illustrating the main components of an electronic device according to a sixth example;

FIG. 9 is a schematic cross-sectional view illustrating the main components of an electronic device according to a seventh example;

FIG. 10 is a schematic cross-sectional view illustrating an electronic device according to a second embodiment; and

FIGS. 11A and 11B are schematic views illustrating electronic devices according to a third embodiment.

### DETAILED DESCRIPTION

In general, according to one embodiment, an electronic device includes an airtight container, a functioning unit, and an airtightness detection unit. The airtight container has a containment space capable of being sealed airtightly. The functioning unit is stored in the containment space. The functioning unit is capable of executing a prescribed function. The airtightness detection unit is stored in the containment space. The airtightness detection unit is capable of detecting an airtightness of the containment space.

Exemplary embodiments will now be described in detail with reference to the drawings.

The drawings are schematic or conceptual; and the relationships between the thickness and width of portions, the proportions of sizes among portions, etc., are not necessarily the same as the actual values thereof. Further, the dimensions and proportions may be illustrated differently among the drawings, even for identical portions.

In the specification and the drawings of the application, components similar to those described in regard to a drawing thereinabove are marked with like reference numerals, and a detailed description is omitted as appropriate.

### First Embodiment

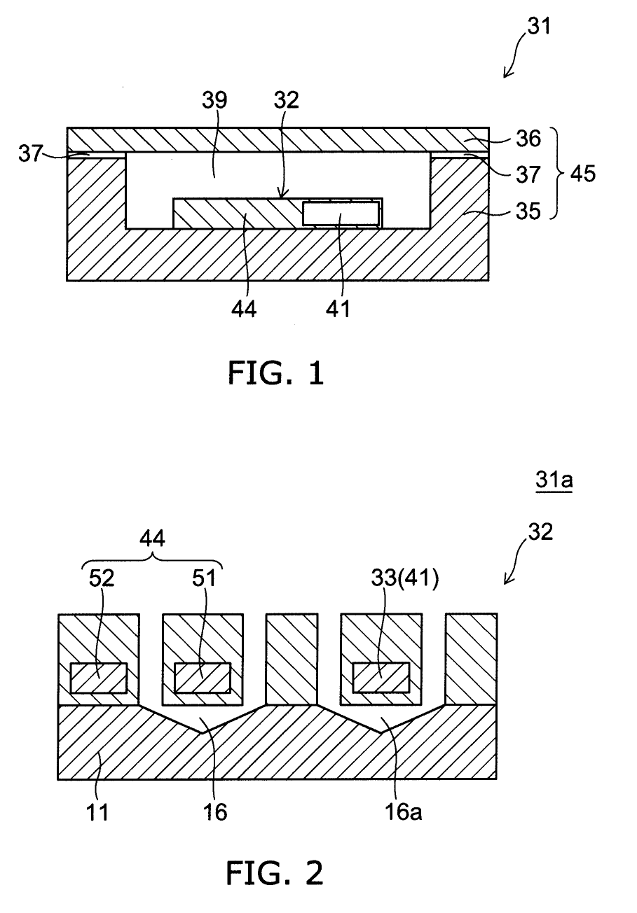

FIG. 1 is a schematic cross-sectional view illustrating the configuration of an electronic device according to a first embodiment.

As illustrated in FIG. 1, the electronic device 31 includes a functioning unit 44, an airtightness detection unit 41, and an airtight package 45 (an airtight container). The airtight package 45 stores the functioning unit 44 and the airtightness detection unit 41 in a containment space and is airtightly sealed.

In this specific example, the airtight package 45 includes a package base member 35, a sealing member 36, and a sealant 37 that airtightly bonds the package base member 35 to the sealing member 36.

In this specific example, the functioning unit 44 and the airtightness detection unit 41 are integrated on the same chip.

For example, the electronic device 31 is formed by fixing a stored element 32, on which the functioning unit 44 and the airtightness detection unit 41 are integrated, to the package base member 35 and subsequently bonding the package base member 35 to the sealing member 36 with the sealant 37 to provide an airtight seal.

The functioning unit 44 may include various functioning elements including various detectors such as an infrared imager (an infrared detection element), a MEMS device such as an acceleration sensor, a microactuator, and the like. A cavity 39 is provided around at least a portion of the functioning unit 44. In the case where the functioning unit 44 is, for example, an infrared imager, the cavity 39 thermally insulates the functioning unit 44 from the external air and the airtight package 45 to improve the function of the infrared imager. In the case where the functioning unit 44 is a MEMS device having a movable portion, the movable portion is movable in the cavity 39. Thus, by storing the functioning unit 44 in the interior of the airtight package 45 with an airtight seal, the functions can be realized and improved.

In other words, depending on the function of the functioning unit 44, the functioning unit 44 and the airtightness detection unit 41 may be sealed in the airtight package 45 with, for example, a vacuum seal, a nitrogen-filled seal, a water vapor-filled seal, etc.

A vacuum sensor, a pressure sensor, a water vapor partial pressure sensor, etc., may be used as the airtightness detection unit 41 to monitor the sealing state.

By the electronic device 31 according to this embodiment, the airtightness detection unit 41 is provided in the interior of the airtight package 45 and can determine the deterioration of the function of the functioning unit 44 due to deterioration of the airtightness by monitoring the fluctuation of the airtightness of the interior of the airtight package 45. Thereby, the short-term and long-term reliability of the electronic device 31 can be ensured.

Thus, the electronic device 31 according to this embodiment can provide an airtight package-type electronic device capable of detecting the airtightness in the airtight container and ensuring the reliability during use.

The function of the functioning unit 44 can be improved by detecting the airtightness. For example, in the case where the functioning unit 44 has a function of detecting infrared rays, the output of the amount of the irradiated infrared rays changes with the degree of vacuum of the environment in which the functioning unit 44 is placed due to fluctuation of the airtightness. In such a case, the infrared detection amount of the functioning unit 44 can be corrected by the airtightness detection unit 41 detecting the degree of vacuum of the environment in which the functioning unit 44 is placed.

It is also possible for the functioning unit 44 to perform an operation in which the fluctuation of the airtightness is corrected by changing the operating conditions of the functioning unit 44 based on the detection result of the airtightness from the airtightness detection unit 41.

Further, by integrating the airtightness detection unit 41 on the same substrate on which the functioning unit 44 is provided, the airtightness detection unit 41 can be formed simultaneously with the process forming the functioning unit 44 instead of being constructed individually; and the manufacturing processes of the electronic device 31 can be simplified drastically.

By integrating the airtightness detection unit 41 and the functioning unit 44 and providing the airtightness detection unit 41 and the functioning unit 44 on the same substrate, the components used in the airtightness detection unit 41 and the functioning unit 44, i.e., the substrate and the various films thereof, may be the same. Therefore, various characteristics such as, for example, the temperature dependency of the components in the airtightness detection unit 41 and the functioning unit 44 become identical. Thereby, the airtightness detection unit 41 can detect the airtightness with a trend similar to the effects of the change of the airtightness on the characteristics of the functioning unit 44. Therefore, the detection of the airtightness can be more practical. Further, as described below, more practical controls, for example, can be performed when controlling the functioning unit 44 by using the detection result of the airtightness from the airtightness detection unit 41.

Vacuum sensors that can be used in the electronic device 31 of this embodiment in the case where the functioning unit 44 and the airtightness detection unit 41 are vacuum-sealed will now be described. Vacuum gauges that measure the degree of vacuum may include, for example,

(1) a sensor that measures the pressure change of a gas in a package as the change of an electrostatic capacitance,

(2) a sensor that measures the change of the heat conduction of a gas in a package as the change of an electrical resistance,

(3) a sensor that measures the change of the viscosity of a gas in a package as the frequency change of a crystal oscillator,

(4) a sensor that measures the change of the discharge resistance of a gas in a package as the change of a discharge current,

and the like. The sensor of (1) that measures the pressure change of the gas in the package as the change of the electrostatic capacitance is not limited to a vacuum sensor. For example, an airtightness sensor in the package having a nitrogen seal also may be used.

For example, vacuum sensors using MEMS technology may include a diaphragm vacuum sensor which is an application of (1) recited above that uses the electrostatic capacitance to detect the deflection of a diaphragm.

Another sensor uses the method of measuring the electrical characteristic change of a diode as an application of (2) recited above. Such a sensor is a vacuum sensor that measures the degree of vacuum by utilizing the fluctuation of an electrical characteristic of a diode that is dependent on the degree of vacuum therearound by mounting a heater proximally to the diode and measuring the electrical characteristic of the diode in a state of the diode being heated by the heater. Such vacuum sensors are developed as solitary vacuum sensors.

### First Example

FIG. 2 is a schematic cross-sectional view illustrating the configuration of the main components of an electronic device according to a first example.

Namely, FIG. 2 illustrates the portions of the functioning unit 44 and the airtightness detection unit 41 illustrated in FIG. 1. In this example, the functioning unit 44 and the airtightness detection unit 41 are vacuum-sealed in the interior of the not-illustrated airtight package 45. A vacuum sensor 33 is used as the airtightness detection unit 41.

As illustrated in FIG. 2, the functioning unit 44 is provided on a substrate 11. The functioning unit 44 includes, for example, a circuit unit 52 and an infrared detection unit 51 which is, for example, a portion having a function of detecting infrared rays. The vacuum sensor 33 is provided on the substrate 11. In other words, the vacuum sensor 33 and the functioning unit 44 are provided on the same substrate. The vacuum sensor 33 is formed with the functioning unit 44 when the functioning unit 44 is formed. In this specific example, the infrared detection unit 51 and the vacuum sensor 33 are maintained apart from the substrate 11.

The vacuum sensor 33 can utilize, for example, the fluctuation of the electrical characteristic of an element dependent on the degree of vacuum therearound as an application of (2) recited above.

In the case where, for example, a resistance element is used as the vacuum sensor 33 and a constant current is provided to the resistance element, the resistance element generates heat, the temperature increases, and the electrical characteristic changes. At this time, a higher degree of vacuum suppresses the heat dissipation from the resistance element emitting heat; and the temperature of the resistance element also increases. Further, the decrease rate of the temperature after stopping the current flow is slower.

On the other hand, as the degree of vacuum decreases, the heat dissipation from the resistance element becomes prominent; and the temperature increase of the resistance element is smaller. Further, the decrease rate of the temperature after stopping the current flow is faster.

It is possible to measure the change of the degree of vacuum using such a principle by monitoring the change of the voltage when, for example, a constant current pulse is provided to the resistance element of the vacuum sensor 33. Also, the change of the current when a constant voltage is applied may be monitored.

Although not illustrated in FIG. 2, the vacuum sensor 33 may include an additional functioning element to cause the vacuum sensor 33 to operate as a detector of the degree of vacuum. Moreover, such a functioning element may be provided in the functioning unit 44.

In such a case, to increase the detection sensitivity of the degree of vacuum, the vacuum sensor 33 may be separated from the substrate 11 as illustrated in FIG. 2; a cavity 16a may be provided on the substrate 11; and the vacuum sensor 33 and the substrate 11 may be thermally insulated from each other.

In other words, the vacuum sensor 33 which is the airtightness detection unit 41 is maintained above the substrate 11 with a space between the vacuum sensor 33 and the substrate 11. In other words, the vacuum sensor 33 has a suspended structure. In such a case, the cavity 16a can be made simultaneously with a similar cavity (a cavity of the functioning unit) 16 of the functioning unit 44 when providing the cavity 16.

A diode, a transistor, a resistor, and an interconnection used as the vacuum sensor 33 may be similar, for example, to a diode of the functioning unit, a transistor of the functioning unit, a resistor of the functioning unit, and an interconnection of the functioning unit used in the functioning unit 44. In other words, at least one selected from a diode, a transistor, a resistor, and an interconnection of the functioning unit 44 and at least one selected from a diode, a transistor, a resistor, and an interconnection of the vacuum sensor 33 may be formed from the same film.

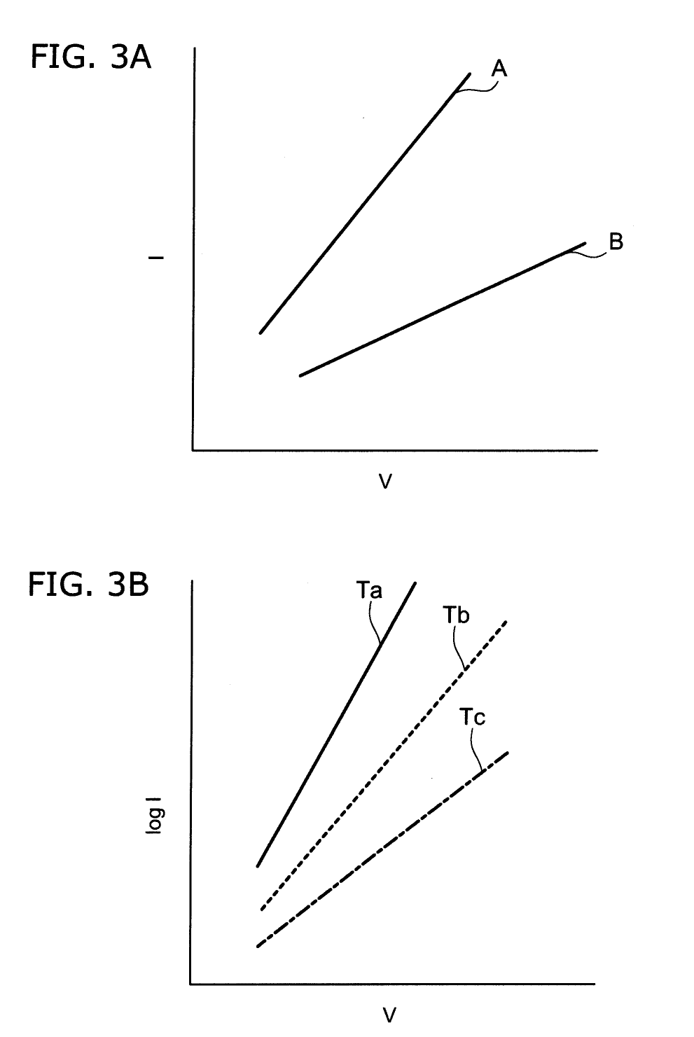

FIGS. 3A and 3B are conceptual schematic views illustrating characteristics of elements which can be used in the electronic device of this embodiment.

Namely, FIG. 3A illustrates the voltage (V)-current (I) characteristic of a resistor which can be used as the vacuum sensor 33; and FIG. 3B illustrates the voltage-current characteristic of a diode which can be used as the vacuum sensor 33.

In the case where a current is provided to a resistor, the resistor generates heat; the temperature of the resistor increases; and, for example, the resistance value of the resistor changes. In the case where a constant current is provided to a resistor as illustrated in FIG. 3A, the heat dissipation from the resistance element which is emitting heat is suppressed when the degree of vacuum of the environment in which the resistor is placed is high (the characteristic B of FIG. 3A); and the heat dissipation from the resistor is prominent when the degree of vacuum is low (the characteristic A of FIG. 3A). Therefore, the voltage-current characteristic of the resistor changes with the degree of vacuum.

This can be utilized by using a resistor as the vacuum sensor 33 and detecting the degree of vacuum from the change of the current-voltage characteristic of the resistor.

In other words, in the case where a constant current is provided to the resistor which is the sensor unit of the vacuum sensor 33, the temperature of the resistor changes with the degree of vacuum; and as a result, the voltage applied to the resistor changes. It is possible to detect the change of the degree of vacuum using such a principle by, for example, monitoring the change of the voltage when a constant current is provided to the resistance element.

The case where an interconnection is used as the vacuum sensor 33 is similar. Herein, although both resistors and interconnections are conductors, resistors refer to components having relatively high resistances, and interconnections refer to components having relatively low resistances.

The case where a diode is used as the vacuum sensor 33 will now be described.

In FIG. 3B, the forward-direction characteristic of a diode is illustrated for three cases of three different temperatures Ta, Tb, and Tc; the voltage (V) is plotted on the horizontal axis; and a logarithm of the current (I) is plotted on the vertical axis. Here, Ta>Tb>Tc.

Although the slopes (log(I)/V) of characteristics a, b, and c corresponding to the temperatures Ta, Tb, and Tc, respectively, are illustrated such that a>b>c in FIG. 3B, the temperature dependency of such slopes differs with the diode voltage.

In the case where, for example, a constant current is provided to the diode as illustrated in FIG. 3B, the heat dissipation from the diode is suppressed as the degree of vacuum increases; and the voltage applied to the diode at that time (hereinbelow referred to as the diode voltage) decreases due to the increase of the temperature of the diode. As the degree of vacuum decreases, the diode voltage increases because the heat dissipation from the diode becomes prominent and the temperature of the diode decreases.

Thus, the degree of vacuum can be detected by using the current-voltage characteristic of the diode in the initial state of the functioning unit 44 and the vacuum sensor 33 which are vacuum-sealed in the airtight package as a reference and monitoring the subsequent change of the current-voltage characteristic.

Similar characteristics can be utilized to detect the degree of vacuum also in the case where a transistor is used as the vacuum sensor 33.

### Second Example

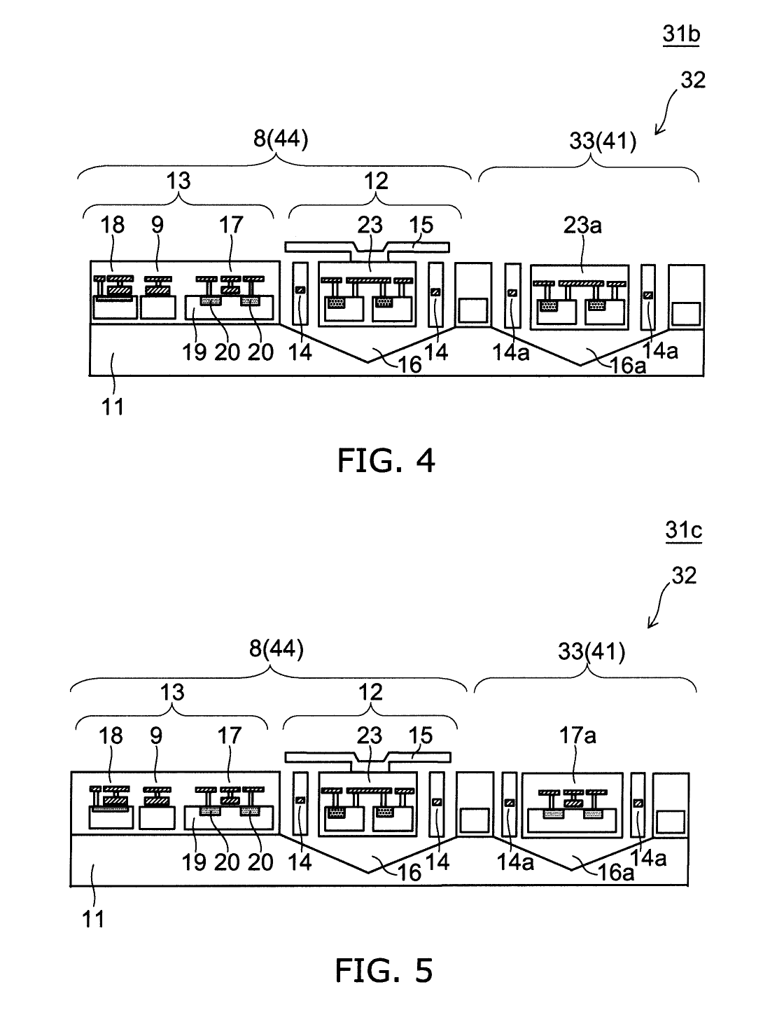

FIG. 4 is a schematic cross-sectional view illustrating the configuration of the main components of an electronic device according to a second example.

Namely, FIG. 4 illustrates portions corresponding to the functioning unit 44 and the airtightness detection unit 41 illustrated in FIG. 1. In this example as well, the functioning unit 44 and the airtightness detection unit 41 are airtightly sealed in the interior of the not-illustrated airtight package 45. In this example, the vacuum sensor 33 is used as the airtightness detection unit 41.

In the electronic device 31b of the second example as illustrated in FIG. 4, an infrared imager 8 is used as the functioning unit 44; and a diode 23a is used as the vacuum sensor 33. The vacuum sensor 33 can detect the degree of vacuum by a mechanism similar to that described in regard to the first example by using the diode 23a. In such a case as well, the vacuum sensor 33 which is the airtightness detection unit 41 is maintained above the substrate 11 with a space between the vacuum sensor 33 and the substrate 11.

The infrared imager 8 and the vacuum sensor 33 are formed by integrating on the substrate 11 made of Si. It is favorable to use an silicon on insulator (SOI) substrate as the substrate 11. The infrared imager 8 includes a thermoelectric conversion pixel 12 and a detection circuit 13.

The thermoelectric conversion pixel 12 includes a diode (a diode of the functioning unit) 23, an interconnection (a interconnection of the functioning unit) 14, and an infrared absorption layer (an infrared absorption layer of the functioning unit) 15 provided on the substrate 11 with the cavity 16 interposed. In other words, the thermoelectric conversion pixel 12 has a suspended structure. The interconnection 14 also has a function of supporting the diode 23 as a support member. The diode 23 may include, for example, a Si-pn junction diode.

The temperature of the diode 23 increases due to the diode 23 absorbing infrared rays. The irradiation amount of the infrared rays can be detected by detecting the change of the voltage-current characteristic of the diode 23 at this time. For example, the irradiation amount of the infrared rays can be determined from the voltage-current characteristic of the forward direction of the diode by determining the change of the voltage in the case where a constant current is provided. Also, the change of the current in the case where a constant voltage is applied may be sensed.

In this specific example, the case is illustrated where two diodes are connected in series. Thus, the detection sensitivity of the infrared rays can be increased by connecting multiple diodes in series. The number of diodes is arbitrary and is not limited to two.

The interconnection 14 includes, for example, polysilicon. The interconnection 14 transmits a signal from the diode 23 to the detection circuit 13.

On the other hand, the infrared absorption layer 15 may include, for example, a silicon oxide film or a silicon nitride film. The infrared absorption layer 15 can increase the detection sensitivity of the infrared rays by absorbing the infrared rays.

Although one thermoelectric conversion pixel 12 is illustrated in this specific example, a two-dimensional infrared image can be obtained by disposing thermoelectric conversion pixels in a matrix configuration and scanning the pixels with prescribed driving conditions.

The detection circuit 13 includes a transistor (a transistor of the functioning unit) 17, a resistor (a resistor of the functioning unit) 9, and a capacitor (a capacitor of the functioning unit) 18. The transistor 17 may include, for example, a Si-MOS transistor which can be constructed by forming a source-drain diffusion layer 20 in a Si layer 19 and forming a gate electrode made of a polysilicon layer with a gate oxide film interposed. The resistor 9 may include, for example, the polysilicon layer used in the transistor 17. The resistance value can be controlled by changing the concentration of the impurity doped into the polysilicon layer. The gate oxide film of the transistor 17 may be used as a capacitor film. Although each one of the functioning elements is illustrated in this specific example, multiple functioning elements may be formed, for example, to provide circuits that perform processing of signals from the thermoelectric conversion pixel 12 and perform drive control of the diode 23 of the thermoelectric conversion pixel 12.

As described above, during the processes of constructing the infrared imager 8 in the electronic device 31b according to this example, the vacuum sensor 33 can be constructed substantially simultaneously with the infrared imager 8 because the diode 23a, which is the sensing unit of the vacuum sensor 33, has the same structure as the diode 23, which is one functioning element of the infrared imager 8. Accordingly, the manufacturing processes of the electronic device can be simplified drastically compared to the case where the infrared imager 8 and the vacuum sensor 33 are constructed separately and mounted separately in the airtight package 45.

### Third Example

FIG. 5 is a schematic cross-sectional view illustrating the configuration of the main components of an electronic device according to a third example.

In the electronic device 31c according to the third example as illustrated in FIG. 5, the infrared imager 8 is used as the functioning unit 44; and a transistor 17a is used as the vacuum sensor 33 which is the airtightness detection unit 41. The infrared imager 8 and the vacuum sensor 33 are stored with a vacuum seal in the not-illustrated airtight package 45. Otherwise, the electronic device 31c is similar to the electronic device 31b, and a description is therefore omitted.

The transistor 17a may have a configuration and materials similar to those of the transistor (the transistor of the functioning unit) 17 used in the infrared imager 8 which is the functioning unit 44.

The function of the transistor 17 as the vacuum sensor 33 is similar to that of the diode described above. Thereby, the vacuum sensor 33 can detect the degree of vacuum.

In other words, for example, a transistor 17a having the same structure as the transistor 17 used in the infrared imager 8 can be constructed on the same substrate 11 made of Si and used as the sensing unit of the vacuum sensor 33. The transistor 17a which is the sensing unit of the vacuum sensor 33 is connected to a not-illustrated drive circuit via an interconnection 14a. The interconnection 14a may have the same structure as the interconnection 14 used in the infrared imager 8.

In such a vacuum sensor 33, the degree of vacuum can be detected from the change of the current-voltage characteristic between the source and drain electrodes when the gate voltage of the transistor 17a has a constant value not less than the threshold voltage. The transistor 17a generates heat when a current is provided between the source and drain electrodes; the temperature of the transistor 17a increases; and the resistance value of the transistor 17a changes. At this time, the heat dissipation from the transistor 17a which is emitting heat is suppressed as the degree of vacuum increases; and as the degree of vacuum decreases, the heat dissipation from the transistor element becomes prominent. It is possible to detect the change of the degree of vacuum using such a principle by, for example, applying the gate voltage having a constant value not less than the threshold voltage to the transistor 17a and monitoring the change of the voltage when a constant current is provided between the source and drain electrodes.

Here, to increase the detection sensitivity of the degree of vacuum, it is favorable for the vacuum sensor 33 to have a suspended structure in which the transistor 17a which is the sensing unit is provided with the interposed cavity 16a as illustrated in FIG. 5. In other words, the vacuum sensor 33 which is the airtightness detection unit 41 is maintained above the substrate 11 with a space between the vacuum sensor 33 and the substrate 11. Such a suspended structure may be formed simultaneously with the process forming the cavity (the cavity of the functioning unit) 16 of the infrared imager 8.

As described above, during the processes of constructing the infrared imager 8 in the electronic device 31c according to this example, the vacuum sensor 33 can be constructed simultaneously with the transistor 17 because the transistor 17a, which is the sensing unit of the vacuum sensor 33, has the same structure as the transistor 17, which is one functioning element of the infrared imager 8. Accordingly, the manufacturing processes of the electronic device can be simplified drastically compared to the case where the infrared imager 8 and the vacuum sensor 33 are constructed separately and mounted separately in the airtight package 45.

### Fourth Example

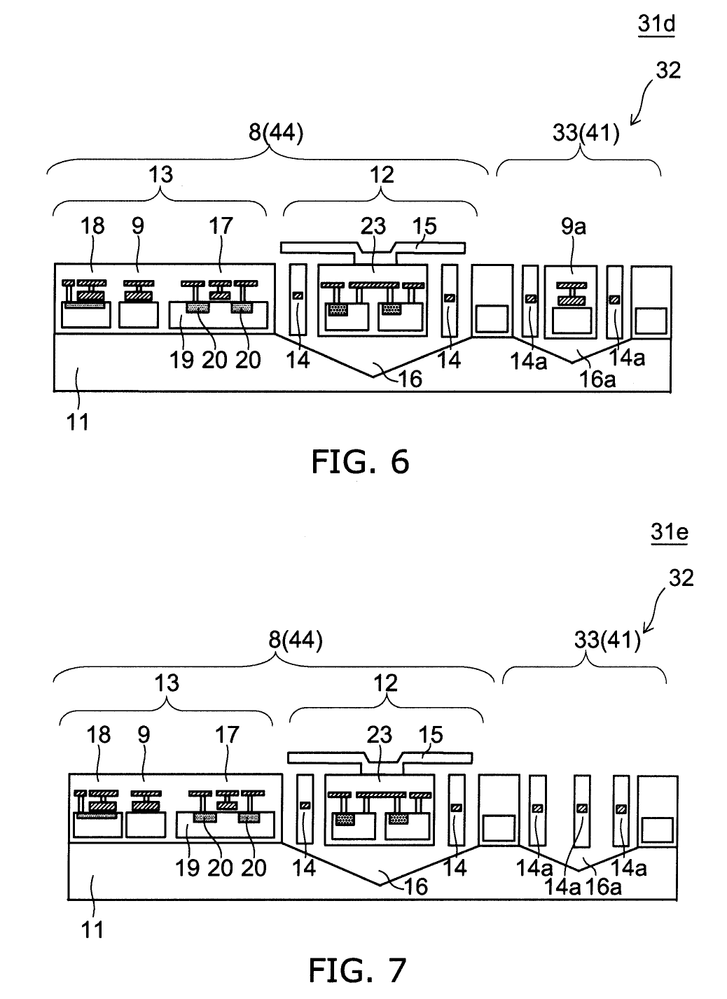

FIG. 6 is a schematic cross-sectional view illustrating the configuration of the main components of an electronic device according to a fourth example.

In the electronic device 31d according to the fourth example as illustrated in FIG. 6, the infrared imager 8 is used as the functioning unit 44; and a resistor 9a is used as the vacuum sensor 33. Otherwise, the electronic device 31d may be similar to the electronic device 31b, and a description is therefore omitted.

The resistor 9a may have a configuration and materials similar to those of the resistor (the resistor of the functioning unit) 9 used in the infrared imager 8 which is the functioning unit 44.

The function of the resistor 9a as the vacuum sensor 33 is similar to that of the diode described above. Thereby, the vacuum sensor 33 can detect the degree of vacuum.

In other words, for example, the resistor 9a having the same structure as the resistor 9 which is one functioning element of the infrared imager 8 can be constructed on the same substrate 11 made of Si and used as the sensing unit of the vacuum sensor 33. The resistor 9a which is the sensing unit of the vacuum sensor 33 is connected to a not-illustrated drive circuit via the interconnection 14a. In such a case, the interconnection 14a also may have the same structure as the interconnection 14 used in the infrared imager 8.

The degree of vacuum can be detected from the change of the current-voltage characteristic of the resistor 9a. The resistor 9a generates heat when a current is provided; the temperature of the resistor 9a increases; and the resistance value of the resistor 9a changes. At this time, the heat dissipation from the resistor 9a which is emitting heat is suppressed as the degree of vacuum increases; and as the degree of vacuum decreases, the heat dissipation from the resistor 9a becomes prominent. It is possible to detect the change of the degree of vacuum using such a principle by, for example, monitoring the change of the voltage when a constant current is provided to the resistor 9a.

Here, to increase the detection sensitivity of the degree of vacuum, it is favorable for the vacuum sensor 33 to have a suspended structure in which the resistor 9a which is the sensing unit is provided with the interposed cavity 16a as illustrated in FIG. 6. In other words, the vacuum sensor 33 which is the airtightness detection unit 41 is maintained above the substrate 11 with a space between the vacuum sensor 33 and the substrate 11. Such a suspended structure also may be formed simultaneously with the process forming the cavity (the cavity of the functioning unit) 16 of the infrared imager 8.

As described above, during the processes of constructing the infrared imager 8 in the electronic device 31d according to this example, the vacuum sensor 33 can be constructed substantially simultaneously with the infrared imager 8 because the resistor 9a, which is the sensing unit of the vacuum sensor 33, has the same structure as the resistor 9, which is one functioning element of the infrared imager 8. Accordingly, the manufacturing processes of the electronic device can be simplified drastically compared to the case where the infrared imager 8 and the vacuum sensor 33 are constructed separately and mounted separately in the airtight package 45.

### Fifth Example

FIG. 7 is a schematic cross-sectional view illustrating the configuration of the main components of an electronic device according to a fifth example.

In the electronic device 31e according to the fifth example as illustrated in FIG. 7, the infrared imager 8 is used as the functioning unit 44; and the interconnection 14a is used as the vacuum sensor 33. Otherwise, the electronic device 31e may be similar to the electronic device 31b, and a description is therefore omitted.

The interconnection 14a may have a configuration and materials similar to those of the interconnection (the interconnection of the functioning unit) 14 used in the infrared imager 8 which is the functioning unit 44.

The function of the interconnection 14 as the vacuum sensor 33 is similar to that of the diode described above. Thereby, the vacuum sensor 33 can detect the degree of vacuum.

In other words, for example, the interconnection 14a having the same structure as the interconnection 14 which is one functioning element of the infrared imager 8 can be constructed on the same substrate 11 made of Si and used as the sensing unit of the vacuum sensor 33. The interconnection 14a which is the sensing unit of the vacuum sensor 33 is connected to a not-illustrated drive circuit. The interconnection 14a may have the same structure as the interconnection 14 used in the infrared imager 8.

The degree of vacuum can be detected from the change of the current-voltage characteristic of the interconnection 14a. The interconnection 14a generates heat when a current is provided; the temperature of the interconnection 14a increases; and the resistance value of the interconnection 14a changes. At this time, the heat dissipation from the interconnection 14a which is emitting heat is suppressed as the degree of vacuum increases; and as the degree of vacuum decreases, the heat dissipation from the interconnection 14a becomes prominent. It is possible to detect the change of the degree of vacuum using such a principle by, for example, monitoring the change of the voltage when a constant current is provided to the interconnection 14a.

Here, to increase the detection sensitivity of the degree of vacuum, it is favorable for the vacuum sensor 33 to have a suspended structure in which the interconnection 14a which is the sensing unit is provided with the interposed cavity 16a as illustrated in FIG. 7. In other words, the vacuum sensor 33 which is the airtightness detection unit 41 is maintained above the substrate 11 with a space between the vacuum sensor 33 and the substrate 11. Such a suspended structure also may be formed simultaneously with the process forming the cavity (the cavity of the functioning unit) 16 of the infrared imager 8.

As described above, during the processes of constructing the infrared imager 8 in the electronic device 31e according to this example as well, the vacuum sensor 33 can be constructed simultaneously with the infrared imager 8 because the interconnection 14a, which is the sensing unit of the vacuum sensor 33, has the same structure as the interconnection 14 used in the infrared imager 8. Accordingly, the manufacturing processes of the electronic device can be simplified drastically compared to the case where the infrared imager 8 and the vacuum sensor 33 are constructed separately and mounted separately in the airtight package 45.

### Sixth Example

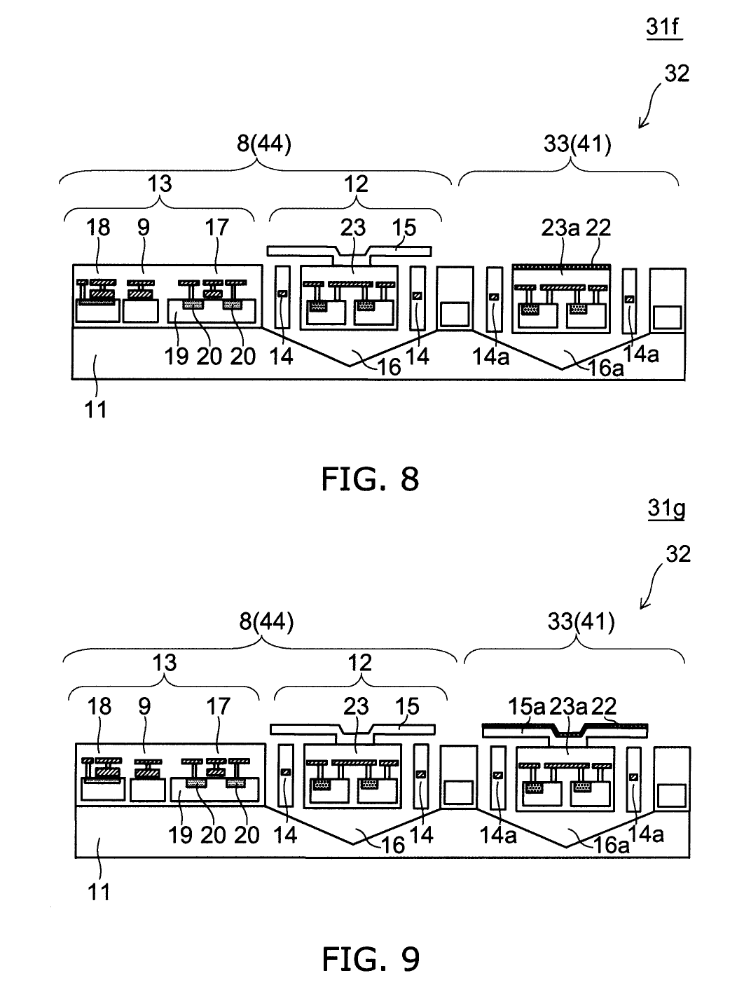

FIG. 8 is a schematic cross-sectional view illustrating the configuration of the main components of an electronic device according to a sixth example.

In the electronic device 31f according to the sixth example as illustrated in FIG. 8, the infrared imager 8 is used as the functioning unit 44; and the diode 23a is used as the vacuum sensor 33. The vacuum sensor 33 further includes an infrared reflection film 22 provided on the diode 23a. These components are vacuum-sealed in the interior of the not-illustrated airtight package 45.

The function of the diode 23a used in the vacuum sensor 33 is similar to that described in regard to the electronic device 31b.

Providing the infrared reflection film 22 on the diode 23a in this example can prevent the infrared rays passing through the airtight package 45 from outside the electronic device 31f from irradiating on the diode 23a. Thereby, the temperature increase of the diode 23a due to the infrared rays irradiated from the outside can be suppressed; and the detection precision of the vacuum sensor 33 can be increased. Further, the deterioration of the vacuum sensor 33 can be suppressed; and the reliability can be increased. The infrared reflection film 22 may include a metal such as, for example, gold, copper, aluminum, etc.

Thus, in the case where the infrared imager 8 is used as the functioning unit 44, it may be supposed that the infrared rays are irradiated also on the vacuum sensor 33. Therefore, by providing the infrared reflection film 22 to cover the diode 23a which is the vacuum sensor 33, the precision of the vacuum detection of the vacuum sensor 33 is increased. As a result, the electronic device 31f can operate with high precision.

The infrared reflection film 22 may be provided to cover the at least one selected from a resistor, an interconnection, a diode, and a transistor used in the vacuum sensor 33.

### Seventh Example

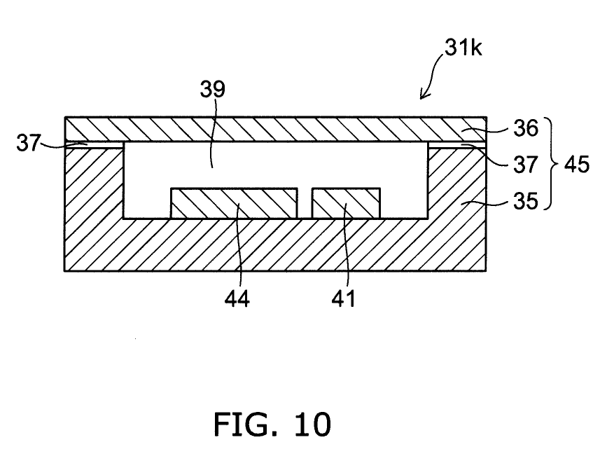

FIG. 9 is a schematic cross-sectional view illustrating the configuration of the main components of an electronic device according to a seventh example.

In the electronic device 31g according to the seventh example as illustrated in FIG. 9, the infrared imager 8 is used as the functioning unit 44; and the diode 23a is used as the vacuum sensor 33. The vacuum sensor 33 includes the infrared reflection film 22 provided on the diode 23a and an infrared absorption layer 15a provided between the infrared reflection film 22 and the diode 23a.

The function of the infrared reflection film 22 may be similar to that of the electronic device 31f.

On the other hand, the infrared absorption layer 15a may have a configuration and materials similar to those of the infrared absorption layer 15 used in the thermoelectric conversion pixel 12 of the infrared imager 8. In other words, the infrared absorption layer 15a may include, for example, a silicon oxide film or a silicon nitride film. By providing the infrared absorption layer 15a in the vacuum sensor 33, the thermal capacity of the diode 23a which is the vacuum sensor 33 can be substantially the same as the thermal capacity of the diode 23 of the thermoelectric conversion pixel 12 in the infrared imager 8. Thereby, in the case where the degree of vacuum in the airtight package 45 changes, feedback correction of the change amount of the degree of vacuum can be provided to a not-illustrated drive control circuit of the infrared imager 8 by measuring the change of the current-voltage characteristic of the diode 23a used in the vacuum sensor 33; and the function of the infrared imager 8 can be improved further.

Although the vacuum sensor 33 used as the airtightness detection unit 41 uses at least one selected from a resistor, an interconnection, a diode, and a transistor and detects the degree of vacuum by utilizing the characteristic of (2) recited above in the electronic devices 31a to 31g according to the first to seventh examples recited above, the embodiments are not limited thereto. In other words, the airtightness detection unit 41 may utilize any of the characteristics illustrated in (1) to (4) recited above or may utilize other characteristics.

Although the infrared imager 8 is used as an example of the functioning unit 44 in the description, the embodiments are not limited thereto. Other functioning elements using MEMS technology, etc., may be used as the functioning unit 44.

### Second Embodiment

FIG. 10 is a schematic cross-sectional view illustrating the configuration of an electronic device according to a second embodiment.

In the electronic device 31k according to this embodiment as illustrated in FIG. 10, the functioning unit 44 and the airtightness detection unit 41 are stored in the interior of the airtight package 45 with an airtight seal. In the case of this specific example, the functioning unit 44 and the airtightness detection unit 41 are constructed separately and disposed individually in the airtight package 45 instead of being formed by integrating on the same substrate. In other words, the electronic device 31k has a hybrid structure. Otherwise, the electronic device 31k may be similar to the electronic device 31 according to the first embodiment.

In such a case as well, a vacuum seal, a nitrogen-filled seal, a water vapor-filled seal, etc., may be provided according to the function of the functioning unit 44. Then, a vacuum sensor, a nitrogen pressure sensor, a water vapor partial pressure sensor, etc., may be used accordingly as the airtightness detection unit 41.

In the case where, for example, a vacuum sensor is used as the airtightness detection unit 41, at least one selected from the configuration described in regard to the first to seventh examples may be employed. In other words, at least one selected from a resistor, an interconnection, a diode, and a transistor may be used as the vacuum sensor; and the degree of vacuum can be detected utilizing the characteristic of (2) recited above. The airtightness detection unit 41 may utilize any of the characteristics illustrated in (1) to (4) recited above or may utilize other characteristics.

In such a case, the airtightness detection unit 41 and the functioning unit 44 are constructed separately for the electronic device 31k according to this embodiment. Therefore, the degrees of freedom of the configuration of the airtightness detection unit 41 increases; the application range is wider; and better convenience is provided. Moreover, any functioning unit 44 and any airtightness detection unit 41 may be constructed individually and combined. Therefore, the time necessary for design and manufacturing is shortened.

By the electronic device 31k according to this embodiment, it is possible to detect the airtightness in an airtight container; the reliability during use can be ensured; and a convenient airtight package-type electronic device can be provided with a wide application range.

By the electronic device 31k according to this embodiment, the deterioration of the function of the functioning unit 44 due to the deterioration of the airtightness can be determined by providing the airtightness detection unit 41 in the interior of the airtight package 45 and monitoring the change of the airtightness from the initial state of the airtight package 45.

### Third Embodiment

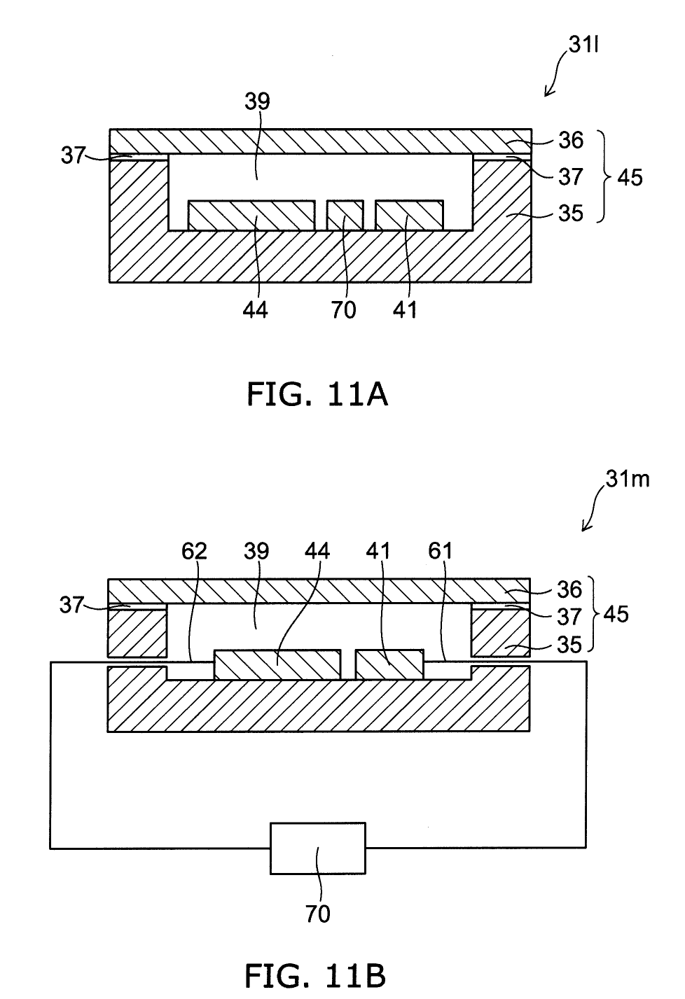

FIGS. 11A and 11B are schematic views illustrating the configurations of electronic devices according to a third embodiment.

Namely, FIGS. 11A and 11B illustrate the structures of two types of electronic devices according to this embodiment.

As illustrated in FIG. 11A, the electronic device 31l according to this embodiment further includes a control unit 70 that controls the functioning unit 44 based on the output of the airtightness detection unit 41.

The control unit 70 controls the functioning unit 44 based on the detection result of the airtightness detected by the airtightness detection unit 41. Thereby, the precision of the operation of the functioning unit 44 can be increased. For example, in the case where the infrared imager 8 is used as the functioning unit 44 and the vacuum sensor 33 is used as the airtightness detection unit 41, the detection result of the infrared rays of the infrared imager 8, for example, can be corrected and output based on the detection result of the degree of vacuum from the vacuum sensor 33. Also, for example, the operating conditions of the infrared imager 8 can be controlled.

In such a case, for example, the detection result of the infrared rays of the infrared imager 8 exhibit a characteristic similar to the vacuum dependency of the electrical characteristics of the elements used in the vacuum sensor 33 such as those illustrated in, for example, FIGS. 3A and 3B. Therefore, the detection result of the infrared rays can be corrected and output, and the operating conditions of the elements used in the infrared imager can be controlled based on such characteristics. Thereby, the detection result of the infrared imager 8 can be maintained at a high precision without depending on the change of the degree of vacuum; and the function can be improved.

Thus, according to the third embodiment, the function of the functioning unit 44 of the electronic device 31l can be improved according to the electronic device 31l.

In this specific example, the functioning unit 44 and the airtightness detection unit 41 are provided separately and stored in the interior of the airtight package 45. In other words, the electronic device 31k according to the second embodiment has a configuration in which the control unit 70 is provided. In such a case, the application range is wider and better convenience is provided as described in regard to the second embodiment; and by further providing the control unit 70, the precision of the function of the functioning unit 44 is increased further.

However, the embodiments are not limited thereto. For example, as in the electronic device 31 according to the first embodiment, the airtightness detection unit 41 may be formed by integrating on the same substrate on which the functioning unit 44 is provided. In such a case, downsizing is possible and the manufacturing costs are suppressed by integrating the airtightness detection unit 41 and the functioning unit 44; and the function can be improved further by linking the characteristics of the functioning unit 44 and the airtightness detection unit 41 by using films having the same configuration for the functioning unit 44 and the airtightness detection unit 41.

The control unit 70 recited above may be provided by integrating on the substrate on which at least one selected from the functioning unit 44 and the airtightness detection unit 41 is provided. Thereby, downsizing is possible, the manufacturing costs can be suppressed, and the precision of the function can be increased further.

In another electronic device 31m according to this embodiment as illustrated in FIG. 11B, the control unit 70 is provided outside the airtight package 45. Thus, the control unit 70 can be provided in at least one selected from inside and outside the airtight package 45.

In the case where the control unit 70 is provided outside the airtight package 45 as in the electronic device 31m, the output of the airtightness detection unit 41, for example, is drawn out from the airtight package 45 by a first interconnection 61 and input to the control unit 70. The output of the control unit 70 is introduced into the airtight package 45 by a second interconnection 62 and input to the functioning unit 44. In such a case, the first interconnection 61 and the second interconnection 62 are provided, for example, to pierce the wall of the airtight package 45 without harming the airtightness of the airtight package 45.

In the electronic devices 31l and 31m according to this embodiment, the functioning unit 44 and the airtightness detection unit 41 may be formed by integrating on the same substrate. In such a case, the controllability of the control unit 70 can be increased further by a contrivance of the configuration.

For example, in the electronic device 31g illustrated in FIG. 9, the thermal capacity of the diode 23a in the vacuum sensor 33 can be substantially the same as the thermal capacity of the diode 23 of the thermoelectric conversion pixel 12 in the infrared imager 8. Thereby, the characteristic change of the diode 23a of the vacuum sensor 33 due to the change of the degree of vacuum can be linked to the characteristic change of the diode 23 of the thermoelectric conversion pixel 12; and the precision of the feedback control by the control unit 70 increases further.

The control unit 70 may be provided in the electronic device according to at least one selected from the first and second embodiments and the first to seventh examples.

Hereinabove, exemplary embodiments are described with reference to specific examples. However, the embodiments are not limited to these specific examples. For example, one skilled in the art may similarly practice the embodiments by appropriately selecting specific configurations of components included in electronic devices from known art. Such practice is included in the scope of the embodiments to the extent that similar effects thereto are obtained.

Further, any two or more components of the specific examples may be combined within the extent of technical feasibility and are included in the scope of the embodiments to the extent that the purport of the embodiments is included.

Moreover, all electronic devices practicable by an appropriate design modification by one skilled in the art based on the electronic devices described above as exemplary embodiments also are within the scope of the embodiments to the extent that the purport of the embodiments is included.

Furthermore, various modifications and alterations within the spirit of the embodiments will be readily apparent to those skilled in the art. All such modifications and alterations should therefore be seen as within the scope of the embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

1. An electronic device, comprising:
an airtight container having a containment space capable of being sealed airtightly;
a functioning unit stored in the containment space, the functioning unit being capable of executing a prescribed function; and
an airtightness detection unit stored in the containment space, the airtightness detection unit being capable of detecting an airtightness of the containment space.

2. The device according to claim 1, wherein the functioning unit is an infrared detection element.

3. The device according to claim 2, wherein the infrared detection element includes at least one selected from a resistor of the functioning unit, an interconnection of the functioning unit, a diode of the functioning unit, and a transistor of the functioning unit.

4. The device according to claim 2, wherein
the containment space is a vacuum, and
the airtightness detection unit is a vacuum sensor.

5. The device according to claim 4, wherein the airtightness detection unit and the functioning unit are provided on an identical substrate.

6. The device according to claim 4, wherein the airtightness detection unit includes at least one selected from a resistor, an interconnection, a diode, and a transistor.

7. The device according to claim 6, wherein the airtightness detection unit includes an infrared reflection film provided to cover the at least one selected from the resistor, the interconnection, the diode, and the transistor included in the airtightness detection unit.

8. The device according to claim 7, wherein the airtightness detection unit further includes an infrared absorption layer provided between the infrared reflection film and the at least one selected from the resistor, the interconnection, the diode, and the transistor included in the airtightness detection unit.

9. The device according to claim 4, wherein the airtightness detection unit is maintained above a substrate with a space between the airtightness detection unit and the substrate.

10. The device according to claim 3, wherein
the containment space is a vacuum, and
the airtightness detection unit is a vacuum sensor.

11. The device according to claim 10, wherein the airtightness detection unit and the functioning unit are provided on an identical substrate.

12. The device according to claim 10, wherein the airtightness detection unit includes at least one selected from a resistor, an interconnection, a diode, and a transistor.

13. The device according to claim 12, wherein the at least one selected from the resistor, the interconnection, the diode, and the transistor included in the airtightness detection unit has the same configuration as the at least one selected from the resistor of the functioning unit, the interconnection of the functioning unit, the diode of the functioning unit, and the transistor of the functioning unit included in the infrared detection element.

14. The device according to claim 12, wherein the airtightness detection unit includes an infrared reflection film provided to cover the at least one selected from the resistor, the interconnection, the diode, and the transistor included in the airtightness detection unit.

15. The device according to claim 14, wherein the airtightness detection unit further includes an infrared absorption layer provided between the infrared reflection film and the at least one selected from the resistor, the interconnection, the diode, and the transistor included in the airtightness detection unit.

16. The device according to claim 15, wherein the at least one selected from the resistor, the interconnection, the diode, and the transistor included in the airtightness detection unit has the same configuration as the at least one selected from the resistor of the functioning unit, the interconnection of the functioning unit, the diode of the functioning unit, and the transistor of the functioning unit included in the infrared detection element.

17. The device according to claim 10, wherein the airtightness detection unit is maintained above a substrate with a space between the airtightness detection unit and the substrate.

18. The device according to claim 10, further comprising a control unit controlling the functioning unit based on an output of the airtightness detection unit.

19. The device according to claim 18, wherein the control unit is stored in the containment space.

20. The device according to claim 18, wherein the control unit and the functioning unit are provided on a same substrate.
